(19) United States
(12) Patent Application Publication
(10) Pub. No.: US 2013/0149602 A1
(43) Pub. Date: Jun. 13, 2013

(54) LITHIUM-ION SECONDARY ELECTROCHEMICAL CELL AND METHOD OF MAKING LITHIUM-ION SECONDARY ELECTROCHEMICAL CELL

(71) Applicants: Shalom Luski, Rehovot (IL); Arieh Meitav, Rishon Lezion (IL); Eli Lancry, Ashdod (IL)

(72) Inventors: Shalom Luski, Rehovot (IL); Arieh Meitav, Rishon Lezion (IL); Eli Lancry, Ashdod (IL)

(73) Assignee: ETV ENERGY LTD, Herzilya (IL)

(21) Appl. No.: 13/520,577

(22) PCT Filed: Jan. 5, 2011
(86) PCT No.: PCT/IB2011/050031

§ 371 Date: Oct. 12, 2012

Related U.S. Application Data
(60) Provisional application No. 61/292,595, filed on Jan. 6, 2010.

(51) Int. Cl. H01M 10/056; H01M 10/0525

(52) U.S. Cl. CPC H01M 10/056; H01M 10/0525
USPC 429/188; 429/231.95; 29/623.1; 29/623.5

(57) ABSTRACT

Disclosed are lithium-ion secondary electrochemical cells and methods of making lithium-ion secondary electrochemical cells.

### RELATED APPLICATION

The present patent application gains priority from U.S. Provisional Patent Application No. 61/292,595 filed 6 Jan. 2010 which is included by reference as if fully set forth herein.

### FIELD AND BACKGROUND OF THE INVENTION

The invention, in some embodiments, relates to the field of secondary electrochemical cells and, more particularly but not exclusively to lithium-ion secondary electrochemical cells.

A secondary electrochemical cell generally includes a negative electrode comprising a negative active material with a reduction potential, a positive electrode comprising a positive active material with an oxidation potential and an electrolyte that allows transport of ions between the electrodes. Electrically insulating the positive electrode from the negative electrode is a separator that is permeable to the passage of ions in the electrolyte. The sum of the reduction potential and the oxidation potential is the standard cell potential of the electrochemical cell.

A well-known type of secondary electrochemical cell is the lithium-ion secondary electrochemical cell. A typical lithium-ion secondary electrochemical cell includes a lithium-ion intercalating material (typically a carbonaceous material such as graphite or hard carbon) as the negative active material and a lithium-ion containing material (e.g., a LiCoO₂) as the positive active material. During cell charging, the positive active material is oxidized, releasing lithium ions into the electrolyte (e.g., LiCoO₂>Li₁₋ₓCO₂+xLi⁺+xe⁻) while lithium ions from the electrolyte are intercalated in the negative active material (xLi⁺+xe⁻+6C>LiₓC₆). During cell discharge, the positive active material is reduced and reintegrates lithium ions from the electrolyte while lithium ions are released from the negative active material.

A lithium-ion secondary electrochemical cell is assembled in an uncharged state and must be charged (a process called formation) for use. During the first few charging events (formation charge) of a lithium-ion secondary electrochemical cell, components of the electrolyte are reduced on the surface of the negative active material and oxidized on the surface of the positive active material, electrochemically forming a solution-electrolyte interphase (SEI) on the active materials. When the SEIs are permeable to lithium ions, non-soluble and non-electrically conductive, the SEIs constitute a protective layer on the positive and negative active materials, preventing deposition of reactive species formed in the electrochemical cell that lead to irreversible capacitance loss.

In some instances, the negative electrode SEI formed during the formation cycles includes imperfection so that the cell suffers, for example, from limited cell cyclability.

### SUMMARY OF THE INVENTION

Some embodiments of the invention relate to secondary electrochemical cells and methods of making secondary electrochemical cells that, in some aspects, have advantages over known secondary electrochemical cells. In some embodiments, the secondary electrochemical cells comprise a lithium-ion containing positive active material having an oxidation potential of at least about 4.2 V vs. Li/Li+. In some embodiments a negative electrode SEI is produced prior to a formation cycle. It has been found in some embodiments such secondary electrochemical cells have improved performance, for example, improved cyclability.

According to an aspect of some embodiments of the invention there is provided a method of making a lithium-ion secondary electrochemical cell, comprising:

a. providing at least one positive electrode having a height, a breadth and a thickness bearing a lithium-ion containing positive active material on at least one face thereof;

b. providing at least one negative electrode having a height, a breadth and a thickness bearing a lithium-ion intercalating negative active material on at least one face thereof;

c. contacting lithium metal with the negative active material; and

d. subsequently to ‘c’, contacting the negative active material and the lithium metal contacted therewith with an electrolyte

thereby allowing oxidation of the lithium metal yielding lithium ions, at least some of which are intercalated in the negative active material.

In some embodiments, the method further comprises, prior to the contacting of the negative active material with the electrolyte, placing the positive electrode and the negative electrode, mutually electrically insulated by at least one separator disposed therebetween to constitute an electrode assembly, in a cell-container. In some embodiments, the contacting of the negative electrode with the electrolyte is during filling of the cell-container with the electrolyte.

In some embodiments, the amount of the lithium metal contacted with the negative active material is such that the oxidation of the lithium metal to the lithium ions lowers the potential of the negative active material. In some embodiments, the potential to which the potential of the negative active material is lowered is a predetermined potential.

In some embodiments, the potential to which the potential of the negative active material is lowered is sufficient to lead to reduction of at least one component of the electrolyte. In some such embodiments, the potential to which the potential of the negative active material is lowered is sufficient to lead to reduction of at least one selected component of the electrolyte. In some embodiments, at least some products of the reduction of at least one component of the electrolyte are deposited on a surface of the negative active material to form at least a portion (and in some embodiments, substantially all) of a negative electrode SEI.

In some embodiments, the positive active material has an oxidation potential of at least about 4.2 V vs. Li/Li+.

According to an aspect of some embodiments of the invention there is also provided a lithium-ion secondary electrochemical cell, comprising:

a. an electrode assembly including:
i. at least one positive electrode having a height, a breadth and a thickness bearing a lithium-ion containing positive active material on at least one face thereof;
ii. at least one negative electrode having a height, a breadth and a thickness bearing a lithium-ion intercalating negative active material on at least one face thereof, facing the positive electrode; and
iii. a separator disposed between the positive electrode and the negative electrode and electrically insulating the positive electrode from the negative electrode; and

b. an electrolyte contacting the positive electrode, the negative electrode and the separator

wherein when an electrolyte (such as the electrolyte mentioned above that is contacting the positive electrode, the negative electrode and the separator) was contacted with the negative electrode, the negative active material was in contact with lithium metal. In some embodiments, the positive active material has an oxidation potential of at least about 4.2 V vs. Li/Li+.

According to an aspect of some embodiments of the invention there is also provided a lithium-ion secondary electrochemical cell, comprising:

a. an electrode assembly including:
i. at least one positive electrode having a height, a breadth and a thickness bearing a lithium-ion containing positive active material on at least one face thereof;
ii. at least one negative electrode having a height, a breadth and a thickness bearing a lithium-ion intercalating negative active material on at least one face thereof, facing the positive electrode; and
iii. a separator disposed between the positive electrode and the negative electrode and electrically insulating the positive electrode from the negative electrode; and

b. an electrolyte contacting the positive electrode, the negative electrode and the separator

wherein a negative electrode SEI on the negative active material includes products of reduction of the electrolyte and is substantially devoid of products formed by reactions at the positive electrode. In some embodiments, the positive active material has an oxidation potential of at least about 4.2 V vs. Li/Li+.

Unless otherwise defined, all technical and scientific terms used herein have the same meaning as commonly understood by one of ordinary skill in the art to which the invention pertains. In case of conflict, the patent specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

As used herein, the indefinite articles “a” and “an” mean “at least one” or “one or more” unless the context clearly dictates otherwise.

### BRIEF DESCRIPTION OF THE FIGURES

Some embodiments of the invention are described herein described with balancing to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIGS. 1A and 1B are a schematic depiction of an electrochemical cell as described herein; and

FIGS. 2A and 2B compare the capacity loss of a secondary electrochemical cell as described herein (FIG. 2A) to the capacity loss of a comparable prior-art secondary electrochemical cell (FIG. 2B).

### DESCRIPTION OF SOME EMBODIMENTS OF THE INVENTION

Aspects of the invention relate to lithium-ion secondary electrochemical cells and methods of making the same.

The principles, uses and implementations of the teachings of the invention may be better understood with reference to the accompanying description and figures. Upon perusal of the description and figures, one skilled in the art is able to implement the teachings of the invention without undue effort or experimentation.

Before explaining at least one embodiment of the invention in detail, it is to be understood that the invention is not limited in its application to the details set forth herein. The invention can be implemented with other embodiments and can be practiced or carried out in various ways. It is also understood that the phraseology and terminology employed herein is for descriptive purpose and should not be regarded as limiting.

As noted above, lithium-ion secondary electrochemical cells are assembled uncharged. One or more positive electrodes bearing a positive active material, one or more negative electrodes bearing a negative active material and one or more separators are assembled to constitute a laminated electrode assembly where a positive active material layer on a positive electrode faces a negative active material layer on a negative electrode, with a separator disposed between the two electrode layers to electrically insulate the two electrode layers one from the other. The laminated electrode assembly having a desired laminated structure (e.g., flat, stacked, jelly-roll) is placed inside a cell-container. An electrolyte is added to saturate the electrodes and the separators, before or after placement in the cell container. The cell-container is sealed so that a positive contact functionally associated with the positive electrode or electrodes and a negative contact functionally associated with the negative electrode or electrodes are accessible (electrically contactable) from outside the sealed cell-container.

For cell charging, the positive and negative contacts are functionally associated with an electrical power source that charges the electrochemical cell by oxidizing a component of the positive active material releasing lithium ions from the positive active material into the electrolyte, loading the negative active material with electrons and intercalating lithium ions from the electrolyte into the negative active material.

During cell discharge, the positive and negative contacts are functionally associated with an electrical load. Electrons move from the negative active material to the positive active material through the electrical load, leading to reduction of a component of the positive active material, release of lithium ions intercalated in the negative active material to the electrolyte and reintegration of lithium ions from the electrolyte into the positive active material.

During the first few charging events (formation cycles), components of the electrolyte are reduced on the surface of the negative active material and oxidized on the surface of the positive active material, forming a lithium ion-permeable electrically-insulating insoluble layer, the solution-electrolyte interphase (SEI), at both electrodes. Formation of the SEI uses charge and therefore reduces the capacity of the cell. However, as the SEI is electrically insulating, once an active material is completely coated with a sufficiently dense SEI layer, no further substantial reduction or oxidation of electrolyte occurs on the surfaces of the active materials so cell capacity remains substantially constant. Additionally, once a sufficiently dense SEI layer is formed, reactions with impurities and gas-formation inside the cell are substantially prevented.

The exact nature of the SEI is determined by the nature of the electrolyte components that are reduced or oxidized at the electrodes. It is known to add additives to the electrolyte to generate an SEI having advantageous properties, see for example Abe K et al Journal of Power Sources 2008, 184, 449-455.

If an SEI includes too many imperfections, reduction or oxidation of electrolyte components with SEI formation may continue, using charge (irreversibly reducing cell capacity so that cell cyclability is reduced) and increasing SEI thickness (increasing cell internal resistance so that the maximal charge rate and the maximal current of the cell are limited).

It is known in the art and experimentally confirmed that lithium-ion secondary electrochemical cells comprising a positive active material having an oxidation potential greater than 4.2 V vs. Li/Li+ have insufficient performance. Specifically, it is seen that such cells suffer from a continuous irreversible capacity loss with each charge/discharge cycle that quickly renders the electrochemical cell unusable.

Although not wishing to be held to any one theory, the Inventors hypothesize that in all electrochemical cells oxidation of electrolyte on the surface of the positive active material produces soluble products, some positively charged, that migrate through the electrolyte to the surface of the negative active material. The amount of these soluble products increases with greater positive active material oxidation potentials, and becomes practically significant at oxidation potentials greater than 4.2 V vs. Li/Li+. Further, with increasing oxidation potential, the nature of the soluble products changes to become more problematic, especially at oxidation potentials greater than 4.2 V vs. Li/Li+.

Further, reduction and oxidation of components of some positive active materials, especially (but not necessarily exclusively) positive active materials having oxidation potentials greater than 4.2 V vs. Li/Li+ leads to the production of soluble metal cations that migrate through the electrolyte to the surface of the negative active material. Formation of such soluble metal cations is exceptionally significant when the positive active material includes manganese, for example in composite lithium metal oxides with a spinel structure having the general formulas LiMn(IV)ₓM_{y}O_{z} (LMS), for example LiMn₂O₄, and LiNi(II)_{w}Mn(IV)ₓM_{y}O_{z} (LiMNS) for example LiNi_{0.5}Mn_{1.5}O₄, where M represents an additional cation such as Al, Ti, Zn and the like, and y is between 0 and 0.5. For example, in some such electrochemical cells, Mn³⁺ cations in the positive active material undergo disproportionation reactions, producing insoluble Mn⁴⁺ and soluble Mn²⁺ cations. The soluble Mn²⁺ cations subsequently migrate through the electrolyte to the negative electrode during a subsequent charging cycles.

Soluble positively-charged entities (e.g., produced by oxidation of electrolyte components or metal cations from the positive active material) produced during the formation cycles, especially with positive active materials having an oxidation potential greater than 4.2 V vs Li/Li+, that reach the negative electrode are reduced on the surface of the negative active material and interfere with the formation of the desired thin, dense and homogenous negative electrode SEI. Additionally, metal cations reduced on the surface of the negative active material potentially form conductive paths through the negative electrode SEI, from the negative active material to the electrolyte. As a result, the negative electrode SEI is ineffective in stopping further reduction reactions of electrolyte components at the negative electrode. During subsequent charge/discharge cycles, further reduction reactions may use charge, leading to electrode imbalance, permanent capacitance loss, formation of gas inside the cell and increasing cell internal resistance.

Aspects of the invention relate to contacting lithium metal with the negative active material of the negative electrode and subsequently contacting the negative active material and the lithium metal with electrolyte. It has been found that in some embodiments, such contacting of negative active material and lithium metal contacted therewith with electrolyte produces an electrochemical cell that overcomes at least some of the challenges described above and in some embodiments leads to an electrochemical cell with improved performance, for example, improved cyclability and a longer cell lifetime due to a reduced extent of capacity loss during charge/discharge cycles.

Although not wishing to be held to any one theory, it is currently believed that in some embodiments contact between the negative active material and lithium metal in the presence of electrolyte leads to a reaction that oxidizes the lithium metal to Li+ ions that are intercalated in the negative active material, in some embodiments lowering the potential of the negative active material vs. Li/Li+.

In some embodiments, the potential to which the potential of the negative active material is lowered is sufficient to lead to reduction of at least one selected component of the electrolyte. In some embodiments, at least some products of the reduction of at least one component of the electrolyte are deposited on a surface of the negative active material to form at least a portion, and in some embodiments substantially all, of a negative electrode SEI.

Since formation of the negative electrode SEI occurs as a result of a reaction before charging of the electrochemical cell, in some embodiments substantially no interfering soluble cations are produced at the positive electrode during the formation of the negative electrode SEI. In some embodiments, the lack of interfering soluble cations produced at the positive electrode results in a negative electrode SEI that is relatively dense and/or relatively homogenous and/or relatively thin and/or substantially non-electrically conductive and/or is includes substantially exclusively products of reduction of the electrolyte at the negative electrode and/or is substantially devoid of products formed by reactions at the positive electrode, especially when compared to a negative electrode SEI produced during a usual formation cycle.

In some embodiments, when the electrochemical cell is subsequently charged, soluble cations formed at the positive electrode that migrate to the negative electrode are electrically insulated from the negative active material by the negative electrode SEI and are therefore not reduced on the negative electrode, cannot substantially interfere with formation of the negative electrode SEI and cannot cause substantial formation of flaws in the negative electrode SEI.

Although applicable to any secondary electrochemical cell, the teachings herein are exceptionally useful for electrochemical cells with a positive electrode bearing a lithium-ion containing positive active material having an oxidation potential of at least about 4.2 V vs. Li/Li+, as the high oxidation potential generally leads to production of a substantial amount of interfering cations and/or to cations that lead to the formation of more significant flaws in the negative electrode SEI.

That said, the teachings herein are also exceptionally useful for some electrochemical cells with a positive electrode bearing a lithium-ion containing positive active material having an oxidation potential lower than 4.2 V vs. Li/Li+, for example, allowing the use of electrolyte solvent components that are relatively easily reduced and therefore not typically be used with a given positive active material.

### Method of Making a Lithium-Ion Secondary Electrochemical Cell

Thus, according to an aspect of some embodiments of the teachings herein there is provided a method of making a lithium-ion secondary electrochemical cell, comprising:

a. providing at least one positive electrode having a height, a breadth and a thickness bearing a lithium-ion containing positive active material on at least one face thereof;

b. providing at least one negative electrode having a height, a breadth and a thickness bearing a lithium-ion intercalating negative active material on at least one face thereof;

c. contacting lithium metal with the negative active material; and

d. subsequent to ‘c’, contacting the negative active material and the lithium metal contacted therewith with an electrolyte

thereby allowing oxidation of the lithium metal yielding lithium ions, at least some of which are intercalated in the negative active material. It is believed that contact of the electrolyte leads to a short circuit between the lithium metal and the contacted negative active material so that the lithium metal is oxidized to lithium ions and the negative active material is reduced.

In some embodiments, the method further comprises prior to the contacting of the negative electrode with electrolyte, placing the positive electrode and the negative electrode, mutually electrically insulated one from the other by at least one separator disposed therebetween to constitute an electrode assembly, in a cell-container. In some embodiments, the contacting of the negative electrode with the electrolyte is during filling of the cell-container with said electrolyte.

### Lithium-Ion Secondary Electrochemical Cell

According to an aspect of some embodiments of the invention there is also provided a lithium-ion secondary electrochemical cell, comprising:

a. an electrode assembly including:
i. at least one positive electrode having a height, a breadth and a thickness bearing a lithium-ion containing positive active material on at least one face thereof;
ii. at least one negative electrode having a height, a breadth and a thickness bearing a lithium-ion intercalating negative active material on at least one face thereof, facing the positive electrode; and
iii. a separator disposed between the positive electrode and the negative electrode and electrically insulating the positive electrode from the negative electrode; and

b. an electrolyte contacting the positive electrode, the negative electrode and the separator

wherein when an electrolyte was contacted with the negative electrode, the negative active material was in contact with lithium metal.

As discussed in greater detail below, in some embodiments, the electrochemical cell further comprises a negative electrode SEI on the negative active material including (in some embodiments, substantially exclusively) products of reduction of the electrolyte and is substantially devoid of products formed by reactions (e.g., reduction or oxidation) at the positive electrode (e.g., during formation cycles).

An electrochemical cell according to the teachings herein generally further comprises a positive contact functionally associated with the positive electrode and a negative contact functionally associated with the negative electrode.

An electrochemical cell as described herein is assembled in any suitable fashion, for example as known in the art. In some embodiments, a desired laminated electrode assembly is made and placed inside a cell-container (e.g., a rigid cell-container such as a cylindrical can or button cell cell-container, or a flexible pouch such as described in U.S. Pat. No. 6,042,966 or 6,048,638). Subsequently, a sufficient amount of electrolyte is added to ensure electrical contact between the positive electrode and the negative electrode. The cell-container is subsequently sealed (usually after one or more degassing cycles), usually so that the positive and negative contacts are accessible from outside the cell-container and the electrochemical cell is ready for charging.

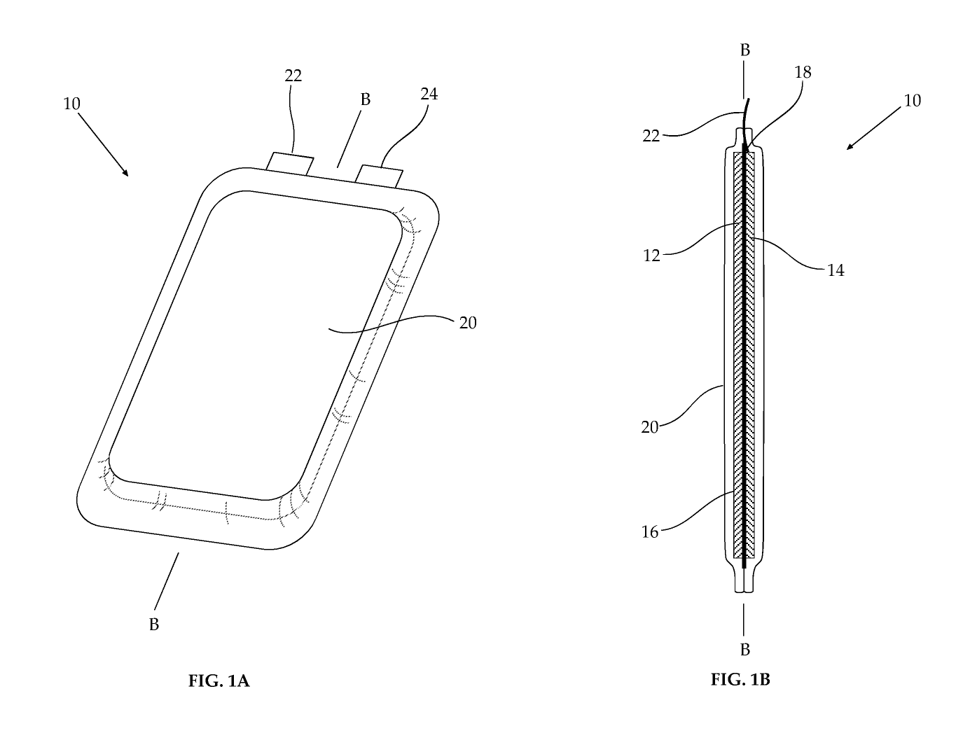

An embodiment of a lithium-ion secondary electrochemical cell in accordance with the teachings herein, cell 10, is depicted in perspective in FIG. 1A and in side cross-section along B-B in FIG. 1B. Cell 10 is pouch cell including a flat electrode assembly, including a separator 12, a positive electrode 14, and a negative electrode 16, together constituting a laminated electrode assembly 18, a flexible pouch 20 (of aluminized foil, e.g., as known in the art), a positive contact 22 and a negative contact 24, contacts 22 and 24 functionally associated with a respective electrode 14 and 16 and accessible from outside pouch 20.

Positive electrode 14 is a substantially flat positive electrode bearing a lithium-ion containing positive active material having an oxidation potential of at least about 4.2 V vs Li/Li+ (e.g., LiNi_{0.5}Mn_{1.5}O₄ with an oxidation potential of 4.9 V vs. Li/Li+) on one face.

Negative electrode 16 is a substantially flat negative electrode bearing negative active material (e.g., graphite) on one face.

The various components are made in the usual way as known in the art, see for example Aurbach D et al in Journal of Power Sources 2006, 162(2), 780-789. Prior to assembly of cell 10, lithium metal is contacted with the negative active material on negative electrode 16, for example powder comprising at least 99.999% lithium metal is distributed over the negative active material, or components such as wires or disks comprising at least 99.999% lithium metal are pressed into the negative active material. Negative electrode 16, separator 12 and positive electrode 14 are stacked together to constitute laminated electrode assembly 18, where separator 12 is disposed between positive electrode 14 and negative electrode 16, where electrodes 14 and 16 are oriented so that the faces bearing the respective active materials face the separator 12 and so that separator 12 electrically insulates the positive electrode 14 from the negative electrode 16. Electrode assembly 18 is then placed inside pouch 20. Pouch 20 is then filled in the usual way with electrolyte (and sealed) thereby contacting negative electrode 16 including the negative active material and the lithium metal with electrolyte. As a result, the lithium metal is oxidized to lithium ions. At least some of the lithium ions are intercalated in the negative active material. The amount of lithium metal contacted with the negative active material, and consequently lithium ions produced, is such that the potential of the negative active material is lowered to a potential sufficient to reduce a component of the electrolyte. Some of the products resulting from the reduction of the electrolyte form a negative electrode SEI on the negative active material. In subsequent charging and recharging cycles, including the formation cycle, soluble products formed at positive electrode 14, for example by reduction and/or oxidation, that migrate to the surface of negative electrode 16 do not settle and are not deposited on the negative active material due to the presence of the already-formed negative electrode SEI.

As a result, pouch cell 10 exhibits superior performance to a comparable cell where the negative active material was not contacted with lithium metal, for example, improved cyclability.

### Electrode Assembly

An electrochemical cell according to the teachings herein generally comprises a laminated electrode assembly including one or more positive electrode layers (made up of the one or more positive electrodes) and one or more negative electrode layers (made up of the one or more negative electrodes), with the appropriate number of separator layers contained inside a cell-container. Any suitable laminated electrode assembly may be used in implementing the teachings herein. In some embodiments, the electrode assembly comprises a flat electrode assembly. In some embodiments, the electrode assembly comprises a stacked electrode assembly including at least one negative electrode and at least one positive electrode. In some embodiments, the electrode assembly comprises a stacked electrode assembly including a plurality of negative electrodes and a plurality of positive electrodes. In some embodiments, the electrode assembly comprises a jelly-roll electrode assembly.

### Cell Container

The electrode assembly may be placed in any suitable cell-container. In some embodiments, the cell-container is a rigid cell-container while in some embodiments, the cell-container is a flexible cell-container, e.g., a pouch and the cell is a pouch-cell.

### Positive Electrode and Positive Active Material

Any positive negative electrode having a height, a breadth and a thickness and bearing any suitable lithium-ion containing positive active material on at least one face thereof may be used in implementing embodiments of the teachings herein. That said and as discussed above, in some preferred embodiments the positive active material is a positive active material having an oxidation potential of at least about 4.2 V vs. Li/Li+ in order to gain the greatest advantages of the teachings herein.

In some embodiments, the lithium-ion containing positive active material has an oxidation potential of at least about 4.3 V vs. Li/Li+. In some embodiments, the lithium-ion containing positive active material has an oxidation potential of at least about 4.4 V vs. Li/Li+. In some embodiments, the lithium-ion containing positive active material has an oxidation potential of at least about 4.5 V vs. Li/Li+. In some embodiments, the lithium-ion containing positive active material has an oxidation potential of at least about 4.6 V vs. Li/Li+. In some embodiments, the lithium-ion containing positive active material has an oxidation potential of at least about 4.7 V vs. Li/Li+. In some embodiments, the lithium-ion containing positive active material has an oxidation potential of at least about 4.8 V vs. Li/Li+.

Known suitable positive active materials include: LiNi_{0.5}Mn_{1.5}O₄ (oxidation potential 4.75 V vs Li/Li+), LiCoPO₄ (oxidation potential 4.8V vs Li/Li+), LiNiVO₄ (oxidation potential 4.8 V vs Li/Li+), and LiNiPO₄ (oxidation potential 5.1V vs Li/Li+).

In some embodiments, the positive active material is selected from the group consisting of spinels and olivines.

In some embodiments, the positive active material comprises manganese ions. Typical suitable positive active materials comprise:

lithium manganese phosphates, for example LiMnPO₄;
positive active materials known as LiNMS (such as LiNiMnCoO₂ and LiNi_{0.5}Mn_{1.5}O₄,) having the formula:

Li(1+r)Ni(0.5−r)Mn(1.5−x)MxO(4−δ)Tδ or Li(1+r)Ni(0.5)Mn(1.5−x)MxO(4−δ)Tδ;
where M represents a cation such as Al, Ti, Cr, Fe, Zn, Mg and the like;
where T represents an anion such as F;
r is between 0 and 0.2;
x is between 0 and 0.2; and
δ is between 0 and 0.2
   and
   positive active materials known as LMS (such as LiMn₂O₄ and LiMnO₄) having the formula:

LiMn(2−x)MxO(4−δ)Tδ,
where M represents a cation such as Al, Ti, Cr, Fe, Zn, Mg and the like;
where T represents an anion such as F;
x is between 0.01 and 0.2; and
δ is between 0 and 0.2.

In some embodiments, suitable positive active materials include materials such as lithium metal oxides, lithium nickel oxides, lithium cobalt oxides, lithium iron oxides, LiMnO₄, LiNiMnCoO₂, LiNiCoAlO₂, LiCoO₂, LiNiO₂, LiCo₁₋ₓNiₓO₂ (0.01≧x≧1), mixtures of LiCoO₂ with LiNiO₂, LiFePO₄, LiFeSO₄ and Li₂FePO₄F, although such materials generally produce less soluble products. In some embodiments, the positive active materials include an amount of other cations, such as cations of Al, Ti, Cr, Fe, Zn, Mg and the like.

In some embodiments, suitable positive active materials include materials such as lithium metal phosphates, (e.g., Li(Mn,Ni,Co)PO₄ with any suitable ratio of the different metal cations) including lithium manganese phosphates (e.g., LiMnPO₄), lithium nickel phosphates (e.g., LiNiPO₄), lithium cobalt phosphates (e.g., LiCoPO₄) and lithium nickel manganese phosphates (e.g., LiNi_{0.5}Mn_{0.5}PO₄).

In some embodiments, a positive electrode is between 30 and 350 micrometer thick, typically between 50 and 200 micrometers thick.

Any suitable positive electrode support, such as known in the art, may be used in implementing the teachings herein. Typically, a positive electrode support also acts as a current collector to transport electrons between the positive contact of the cell and the positive active material. Suitable positive electrode-support include meshes, foils and plates of materials such as aluminum, aluminum alloys, gold, gold alloys, platinum, platinum alloys, titanium, titanium, alloys and combinations thereof. In some embodiments, a positive electrode support is permeable to the passage of lithium ions, e.g., a porous micromesh such as a copper micromesh. In some embodiments, a positive electrode support is impermeable to the passage of lithium ions, e.g., a solid copper foil.

In some embodiments, a positive electrode is between 30 and 350 micrometer thick, typically between 50 and 200 micrometers thick.

A positive electrode is generally functionally associated with a positive contact, for example a wire or a strip of conductive material, integrally formed or attached, for example by welding, to the positive electrode support, to transport electrons to and from the positive electrode. A positive contact is generally accessible (electrically contactable) from outside the cell-container of the electrochemical cell.

Any suitable method may be used for producing a positive electrode, for example as described in US patent publication 2008/0254367 or WO 2006/073277. Generally, a positive electrode is made by applying a layer of a slurry comprising the positive active material, a conductive material, a binder and a solvent to at least one face of an electrode-support. The slurry is dried, leaving a layer of positive active material attached to the electrode-support.

For example, powdered positive active material is kneaded together with a conductive material such as acetylene black or carbon black, a binder such as ethylene propylene diene terpolymer (EPDM), polytetrafluoroethylene (PTFE), poly(vinylidene fluoride) (PVDF), styrene-butadiene copolymer (SBR), acrylonitrile-butadiene copolymer (NBR) or carboxymethylcellulose (CMC) to give a positive active material composition. The positive active material composition is mixed with a solvent such as 1-methyl-2-pyrrolidone to form a slurry. At least one face of a positive electrode-support is coated with a layer of the slurry, and the coated electrode-support heated at between about 50° C. and about 250° C. under vacuum for a sufficient time for drying, for example between 1 and 24 hours, providing a positive electrode.

### Negative Electrode and Negative Active Material

Any suitable negative electrode having a height, a breadth and a thickness and bearing any suitable lithium intercalating negative active material on at least one face thereof may be used in implementing embodiments of the teachings herein.

In some embodiments, a negative electrode as described herein is between 30 and 300 micrometer thick, typically between 100 and 200 micrometers thick.

Any suitable lithium intercalating negative active material may be used in implementing the teachings herein. Some embodiments include at least one negative active material selected from the group consisting of metals (e.g., tin, aluminum), silicon, silicates, SnO₂, TiO₂ and intermediary alloys. Some embodiments include at least one negative active material that is a carbonaceous materials (e.g., a lithium-intercalating material that is primarily carbon) such as cokes, graphites, hard carbons, soft carbons, fired organic polymers, carbonaceous fibers or mixtures thereof.

Any suitable negative electrode support, such as known in the art, may be used in implementing the teachings herein. Typically, a negative electrode-support also acts as a current collector to transport electrons between a negative contact of the cell and the negative active material. Suitable electrode-supports include meshes, foils and plates of materials such as copper, copper alloys, nickel, nickel alloys, gold, gold alloys, platinum, platinum alloys, titanium, titanium, alloys and combinations thereof. In some embodiments, a negative electrode support is permeable to the passage of lithium ions, e.g., a porous micromesh such as copper micromesh. In some embodiments, a negative electrode support is impermeable to the passage of lithium ions, e.g., a solid copper foil.

A negative electrode is generally functionally associated with a negative contact, for example a wire or a strip of conductive material, integrally formed or attached, for example by welding, to the negative electrode, to transport electrons to and from the negative electrode. A negative contact is generally accessible (electrically contactable) from outside the cell-container of the electrochemical cell.

Any suitable method may be used for producing a negative electrode, for example as described in US patent publication 2008/0254367 or WO 2006/073277. Generally, a negative electrode is made by applying a layer of a slurry comprising the negative active material, a conductive material, a binder and a solvent to at least one face of an electrode-support. The slurry is dried, leaving a layer of negative active material attached to the electrode-support. For example, powdered carbonaceous negative active material is mixed with a binder such as ethylene propylene diene terpolymer (EPDM), polytetrafluoroethylene (PTFE), poly(vinylidene fluoride) (PVDF), styrene-butadiene copolymer (SBR), acrylonitrile-butadiene copolymer (NBR) or carboxymethylcellulose (CMC) to give a negative active material composition. The negative active material composition is mixed with a solvent such as 1-methyl-2-pyrrolidone to form the slurry. At least one face of a negative electrode-support is coated with a layer of the slurry, and the coated electrode-support heated at between about 50° C. and about 250° C. under vacuum for a sufficient time for drying, for example between 1 and 24 hours, providing a negative electrode.

### Separator

Like known electrochemical cells, embodiments of an electrochemical cell described herein comprise a separator positioned between the positive electrode and the negative electrodes and electrically-insulating the positive electrode from the negative electrode. Any suitable separator, such as known in the art, may be used for implementing the teachings herein, especially separators suitable for use for lithium-ion electrochemical cells.

Generally, a separator is a sheet having a height, a breadth, a thickness, is electrically insulating and is permeable to the passage of lithium ions.

Typically, there is at least one separator disposed between every positive electrode and negative electrode to prevent physical contact (with concomitant short circuit) of the positive electrode and negative electrode but to allow the passage of lithium ions during charge and discharge of the electrochemical cell.

Typical separators comprise one or more sheets of suitable materials such as microporous polyolefins (e.g., polyethylene or polypropylene film, fluorinated polyolefin films), other microporous films, woven fabrics and non-woven fabrics. Suitable sheets are commercially available, for example from Such separators are commercially available, e.g., from Ube Industries, Tokyo, Japan or Celgard LLC, Charlotte, N.C., USA.

As is known in the art, it is preferred that a separator be as thin and porous as possible in order to allow maximal power density and minimal internal resistance, but must also be physically strong enough to maintain physical integrity to increase electrochemical cell reliability without short-circuits. In some embodiments, a separator is made of one or more sheets of separator material so that the separator is typically between about 5 and about 200 micrometers thick, more typically between about 10 and about 60 micrometers thick, preferably between about 20 and about 50 micrometers thick.

### Electrolyte

An electrolyte is the medium that allows migration of lithium ions (and in some embodiments, other ions) into and out of the positive and negative active materials and through the separator. In some embodiments, one or more components of the electrolyte are reduced forming a negative electrode SEI, as described above.

Any suitable electrolyte may be used for implementing the teachings herein such as known in the art, for example a liquid or gel electrolyte solution.

In some embodiments, an electrolyte comprises at least one lithium salt in a non-aqueous solvent including one or more solvent components. Typical lithium salts include lithium salts selected from the group consisting of LiPF₆, LiBF₄, LiClO₄, LiN(SO₂CF₃)₂, LiN(SO₂C₂F₅)₂, LiC(SO₂CF₃)₃, LiPF₄(CF₃)₂, LiPF₃(C₂F₅)₃, LiPF₃(CF₃)₃, LiPF₃(iso-C₃F₇), LiPF₅(iso-C₃F₇), lithium bis(oxalato)borate (LiBOB), lithium difluorooxalatoborate (LiDFOB) and combinations thereof. In some embodiments, an electrolyte comprises two, three or more different lithium salts. In some embodiments, the concentration of the lithium salts in the electrolyte are between about 0.1 M and about 3 M, in some embodiments between about 0.5 M and about 1.5 M.

In some embodiments, an electrolyte comprises at least one non-aqueous solvent including one or more solvent components. In some embodiments, one or more solvent components are selected from the group consisting of cyclic carbonates such as ethylene carbonate (EC), propylene carbonate (PC), butylene carbonate (BC), and vinylene carbonate (VC); linear carbonates such as dimethyl carbonate (DMC), methyl ethyl carbonate (MEC), diethyl carbonate (DEC), dipropyl carbonate (DPC); lactones such as gamma-butylolactone (GBL); ethers such as tetrahydrofuran (THF), 2-methyl-tetrahydrofuran, 1,4-dioxane, 1,2-dimethoxyethane, 1,2-diethoxyethane, and 1,2-dibutoxyethane; nitriles such as acetonitrile; esters such as methyl propionate, methyl pivalate and octyl pivalate; N-methyl-2-pyrrolidone (NMP), sulfolane and adiponitrile and combinations thereof. In some embodiments an electrolyte comprises a mixture of two, three or more different non-aqueous solvents.

In some embodiments, an electrolyte further comprises one or more additives for modifying the characteristics of the electrolyte such as one or more of increased safety, formation of an advantageous positive electrode SEI and formation of an advantageous negative electrode SEI. In some embodiments, an electrolyte includes at least one SEI forming-additive. Any suitable additive can be used, for example negative-electrode SEI-forming additives known in the art such as described in Abe K et al (J. Power Sources 2008, 184, 449-455) and references cited therein, which are included by reference as if fully set forth herein. Typical additives include additives selected from the group consisting of propargyl methyl sulfate (PMS), propargyl methyl carbonate (PMC), allyl methanesulfonate (AMS), vinylene carbonate (VC), 1,3-propane sultone (PS), ethylene carbonate (EC), fluorinated ethylene carbonate (FEC), ethylene sulfite, propylene sulfite, vinylene ethylene carbonate (VEC) and vinyl acetate (VA).

In some embodiments lithium salts are added as SEI-forming additives, for example LiDFOB and LiBOB.

In some embodiments, an electrolyte comprises one or more SEI-forming additives configured to be reduced at the negative electrode upon electrolyte contact with the negative active material and the lithium metal, where the reduction products modify the formed negative electrode SEI.

Typically, an electrolyte is made by mixing the different components together.

### Lithium Metal

As noted above, in some embodiments of the teachings herein, lithium metal is contacted with negative active material of a negative electrode prior to contact of the negative active material with electrolyte. The lithium metal contacted with the negative active material to implement the teachings herein generally constitutes any suitable component including lithium metal. In some embodiments, the component includes not less than about 95%, not less than about 98%, not less than about 99%, not less than about 99.9%, not less than about 99.99% and even not less than about 99.999% lithium metal by weight.

The lithium metal contacted with the negative active material to implement the teachings herein generally constitutes a component having any suitable form, e.g., sheets, foils, plates, threads, wires, ribbons, strips, filaments, chips, particles, powders, buttons and knobs.

In some embodiments, e.g., cell 10 in FIG. 1, only one face of the negative electrode bears negative active material and so the lithium metal is contacted with the negative active material on the one face.

In some embodiments, a secondary electrochemical cell includes an electrode assembly comprising a stacked electrode assembly as known in the art. As the name indicates, in some such embodiments, the electrode assembly comprises alternating positive and negative electrodes separated by separator layers. The minimal such electrochemical cell includes two positive electrodes, two separators and one negative electrode or two negative electrodes, two separators and one positive electrode. That said, in some embodiments, stacked electrode assemblies include a plurality of positive and negative electrode layers. Generally, all but the two terminal electrode layers include two faces both bearing a respective active material. In some embodiments both faces of the two terminal electrode layers bear active material. In some embodiments, only one face of each of the two terminal electrode layers bear active material.

In some embodiments, two faces of a negative electrode bear negative active material (e.g., embodiments including a stacked or jelly-roll electrode assembly) and the lithium metal is contacted with two faces of the negative electrode. In some such embodiments, contact of the electrolyte allows oxidation of the lithium metal to lithium ions which are intercalated in negative active material on both faces of the negative electrode.

In some embodiments, two faces of the negative electrode bear negative active material (e.g., embodiments including a stacked or jelly-roll electrode assembly) but the lithium metal is contacted with only one face of the negative electrode. In some such embodiments, the electrode support is permeable to the passage of lithium ions (e.g., a porous electrode support such as of micromesh copper) so that contact of the electrolyte allows oxidation of the lithium metal to lithium ions which can pass from one face of the electrode to the other face, allowing the lithium ions to be intercalated in negative active material on both faces of the negative electrode.

In some embodiments, including embodiments comprising planar, stacked and jelly-roll electrode assemblies, one or more lithium metal components are placed in contact with the negative active material (on one or more faces of the negative electrode or electrodes) and pressed thereinto with the application of pressure, for example with the use of a press.

In some embodiments, a secondary electrochemical cell includes an electrode assembly comprising a jelly-roll structure as known in the art. In some such embodiments, the positive and negative electrodes are sheets where both faces of both sheets bear respective active material. In some embodiments, negative active material on only one face of the negative electrode is contacted with lithium metal while in some embodiments both faces of the negative electrode are contacted with lithium metal. The positive and negative electrodes are wound or rolled together as known in the art (for example, on a mandrel) with two separator sheets and the electrode assembly (comprising a positive electrode, a negative electrode and the two separators) to make the jelly-roll structure where a separator is always interposed between any two layers of negative and positive electrode.

In some embodiments, including embodiments comprising a “jelly-roll” electrode assembly, the lithium metal component is intermittently or continuously distributed in contact with one or more faces of the negative electrode. For example, in some embodiments, the ends of one or more lithium wires are placed in contact with negative active material between a separator and a negative electrode and then wound about a mandrel together with the components of the electrode assembly. For example, in some embodiments, buttons or knobs of lithium metal are placed intermittently, e.g., every half rotation, on one or both surfaces of a negative electrode as the electrode assembly is wound about a mandrel. For example, in some embodiments, lithium metal powder is continuously distributed on the negative active material as the electrode assembly is wound about a mandrel.

The amount of lithium metal contacted with the negative active material to implement the teachings herein is any suitable amount. In some embodiments, the amount of the lithium metal (number of atoms) is less than the amount (number) of lithium intercalating sites of the negative active material. In some embodiments, the amount of the lithium metal is not more than about 50% and even not more than about 30% of the amount of lithium intercalating sites of the negative active material. In some embodiments, the amount of the lithium metal is at least about 1%, at least about 2% and even at least about 3% of the amount of lithium intercalating sites of the negative active material. In some embodiments, the amount of the lithium metal is between about 10% and about 40% of the amount of lithium intercalating sites of the negative active material. In some embodiments, the amount of the lithium metal is between about about 20% and about 30% (e.g., about 25%) of the amount of lithium intercalating sites of the negative active material.

That said, generally the greater the amount of lithium metal that is contacted with the negative active material, the lower the potential of the negative active material becomes subsequent to contact of the electrolyte, that in some embodiments influences the nature of the products formed by reduction of the electrolyte components and thus the nature of a negative electrode SEI formed.

Thus, in some embodiments, the teachings herein provide a lithium-ion secondary electrochemical cell (substantially as described hereinabove) wherein a negative electrode SEI on the negative active material comprises products of reduction of the electrolyte (effected by contact of electrolyte with lithium metal and the negative active material according to the teachings herein) and is substantially devoid of products formed by reactions at the positive electrode , e.g., during a formation cycle.

Thus, in some embodiments, the amount of lithium metal contacted with the negative active material is such that oxidation of the lithium metal to lithium ions lowers the potential of the negative active material.

In some embodiments, the potential to which the potential of the negative active material lowered is a predetermined potential, that is to say, the amount of lithium metal contacted with the negative active material is calculated so that the potential is a specific desired potential. In some embodiments, prior to making a given electrochemical cell, a sample of the negative active material is titrated with lithium metal in the usual way to determine the potential of the negative active material as a function of the amount of lithium metal to generate a look-up table that allows simple calculation of the amount of lithium metal to be added to achieve a specific predetermined potential when the electrochemical cell is actually made.

In some embodiments, the potential to which the potential of the negative active material is lowered is sufficient to lead to reduction of at least one component of the electrolyte. In some embodiments, the potential to which the potential of the negative active material is lowered is sufficient to lead to reduction of at least one selected component of the electrolyte. In some such embodiments, at least some products of the reduction of the at least one component of the electrolyte are deposited on a surface of the negative active material to form at least a portion (preferably substantially all) of a negative electrode SEI.

In some embodiments, the potential to which the potential of the negative active material is lowered is not more than 200 mV, in some embodiments not more than about 100 mV, in some embodiments not more than about 75 mV and in some embodiments not more than about 50 mV of the potential sufficient to lead to the reduction of at least one selected component of the electrolyte. In some embodiments, the potential to which the potential of the negative active material is lowered is not more than about 2 V relative to Li/Li+.

For example, 1,3-propane sultone is reduced at about 2.1 V relative to Li/Li+. In some embodiments, the electrolyte comprises 1,3-propane sultone and the amount of lithium metal contacted with the negative active material is such that upon contact with electrolyte in accordance with the teachings herein, the potential of the negative active material is lowered to not more than about 2.1 V relative to Li/Li+ leading to reduction of 1,3-propane sultone, at least some of which products form at least a portion of a negative electrode SEI. In some such embodiments, the amount of lithium metal contacted with the negative active material is such that the potential of the negative active material is lowered to between about 2.1 V and about 1.9 V, between about 2.1 V and about 2.0 V, between about 2.1 V and about 2.025 V and even between about 2.1 V and about 2.05 V relative to Li/Li+. In some such embodiments, the negative electrode SEI on the negative active material of the resulting electrochemical cell, comprises products of the reduction of 1,3-propane sultone (in some embodiments, together with products of reduction of other electrolyte components) and in some embodiments is substantially devoid of products formed by reactions at the positive electrode (e.g., during a formation cycle).

For example, ethylene sulfite and propylene sulfite are reduced at about 2.0 V relative to Li/Li+. In some embodiments, the electrolyte comprises ethylene sulfite and/or propylene sulfite and the amount of lithium metal contacted with the negative active material is such that upon contact with electrolyte in accordance with the teachings herein, the potential of the negative active material is lowered to not more than about 2.0 V relative to Li/Li+ leading to reduction of ethylene sulfite and/or propylene sulfite, at least some of which products form at least a portion of the negative electrode SEI. In some such embodiments, the amount of lithium metal contacted with the negative active material is such that the potential of the negative active material is lowered to between about 2.0 V and about 1.8 V, between about 2.0 V and about 1.9 V, between about 2.0 V and about 1.925 V and even between about 2.0 V and about 1.95 V relative to Li/Li+. In some such embodiments, the negative electrode SEI on the negative active material of the resulting electrochemical cell, comprises products of the reduction of ethylene sulfite and/or propylene sulfite (in some embodiments, together with products of reduction of other electrolyte components) and in some embodiments is substantially devoid of products formed by reactions at the positive electrode (e.g., during a formation cycle).

For example, LiBOB is reduced at about 1.7 V relative to Li/Li+. In some embodiments, the electrolyte comprises LiBOB and the amount of lithium metal contacted with the negative active material is such that upon contact with electrolyte in accordance with the teachings herein, the potential of the negative active material is lowered to not more than about 1.7 V relative to Li/Li+ leading to reduction of LiBOB, at least some of which products form at least a portion of a negative electrode SEI. In some such embodiments, the amount of lithium metal contacted with the negative active material is such that the potential of the negative active material is lowered to between about 1.7 V and about 1.5 V, between about 1.7 V and about 1.6 V, between about 1.7 V and about 1.625 V and even between about 1.7 V and about 1.65 V relative to Li/Li+. In some such embodiments, the negative electrode SEI on the negative active material of the resulting electrochemical cell, comprises products of the reduction of LiBOB (in some embodiments, together with products of reduction of other electrolyte components) and in some embodiments is substantially devoid of products formed by reactions at the positive electrode (e.g., during a formation cycle).

For example, vinylene carbonate (VC) is reduced at about 1.4 V relative to Li/Li+. In some embodiments, the electrolyte comprises VC and the amount of lithium metal contacted with the negative active material is such that upon contact with electrolyte in accordance with the teachings herein, the potential of the negative active material is lowered to not more than about 1.4 V relative to Li/Li+ leading to reduction of vinylene carbonate, at least some of which products form at least a portion of a negative electrode SEI. In some such embodiments, the amount of lithium metal contacted with the negative active material is such that the potential of the negative active material is lowered to between about 1.4 V and about 1.2 V, between about 1.4 V and about 1.3 V, between about 1.4 V and about 1.325 V and even between about 1.4 V and about 1.35 V relative to Li/Li+. In some such embodiments, the negative electrode SEI on the negative active material of the resulting electrochemical cell, comprises products of the reduction of vinylene carbonate (in some embodiments, together with products of reduction of other electrolyte components) and in some embodiments is substantially devoid of products formed by reactions at the positive electrode (e.g., during a formation cycle).

For example, ethylene carbonate (EC) is reduced at about 1.3 V relative to Li/Li+. In some embodiments, the electrolyte comprises EC and the amount of lithium metal contacted with the negative active material is such that upon contact with electrolyte in accordance with the teachings herein, the potential of the negative active material is lowered to not more than about 1.3 V relative to Li/Li+ leading to reduction of ethylene carbonate, at least some of which products form at least a portion of a negative electrode SEI. In some such embodiments, the amount of lithium metal contacted with the negative active material is such that the potential of the negative active material is lowered to between about 1.3 V and about 1.1 V, between about 1.3 V and about 1.2 V, between about 1.3 V and about 1.225 V and even between about 1.3 V and about 1.25 V relative to Li/Li+. In some such embodiments, the negative electrode SEI on the negative active material of the resulting electrochemical cell, comprises products of the reduction of ethylene carbonate (in some embodiments, together with products of reduction of other electrolyte components) and in some embodiments is substantially devoid of products formed by reactions at the positive electrode (e.g., during a formation cycle).

### Example

Reference is now made to the following example, which together with the above description, illustrates some embodiments of the invention in a non limiting fashion.

A lithium-ion secondary electrochemical cell including a negative electrode assembly as described herein was made and tested using methods analogous to the known in the art with the appropriate modifications, for example as described in Gnanaraj J S (Electrochem. Comm. 2003, 5, 940-945), in Aurbach D et al (J Power Sources 2006, 162(2), 780-789), Abe K et al (J. Power Sources 2008, 184, 449-455) and US 2008/0254367 which are included by reference as if fully set-forth herein. Unless otherwise stated, materials and reagents were available from Sigma Chemical Company (St. Louis, Mo., USA), Ube Industries Ltd. (Tokyo, Japan) and Hitachi Chemical Co., Ltd. (Tokyo, Japan).

A positive electrode slurry composition was fashioned in the usual way with 80 parts powdered LiNi_{0.5}Mn_{1.5}O₄ (oxidation potential 4.75V vs Li/Li+ as described in Aurbach D using a self-combustion reaction) as a positive active material, 10 parts carbon black (Super P® from by TIMCAL Ltd., Bodio, Switzerland) and 10 parts PVDF (polyvinylidene fluoride, 10% in NMP) as a binder. About 30% additional NMP (N-methyl-2-pyrrolidone) was added to achieve a workable viscosity.

One face of a 3 cm by 3.5 cm square of 12 micrometer thick copper foil positive electrode-support and current collector with an ultrasonically welded nickel tab (100 micron thick, 3 cm long, 0.5 cm wide) positive contact was coated with a 300 micrometer thick layer of the positive electrode slurry composition including about 80mg positive active material. The positive electrode was densified in the usual way using a rolling mill. The densified positive electrode was dried under vacuum at 100° C. for 20 hours.

A negative electrode slurry composition was fashioned in the usual way with 90 parts graphite as a negative active material, 5 parts carbon black and 5 parts PVDF (polyvinylidene fluoride, 10% in NMP) as a binder. About 30% additional NMP (N-methyl-2-pyrrolidone) was added to achieve a workable viscosity.

One face of a 3 cm by 3.5 cm square of 20 micrometer thick aluminum foil negative electrode-support and current collector with an integrally formed aluminum tab (3 cm long, 0.5 cm wide) negative contact was coated with a 150 micrometer thick layer of the negative electrode slurry composition including about 40 mg negative active material. The negative electrode was densified in the usual way using a rolling mill. The densified negative electrode was dried under vacuum at 100° C. for 20 hours.

A 1.5 mm diameter disk of 250 micrometer thick battery-grade lithium foil was pressed against the negative active material of the negative electrode so that the lithium was pressed into and adhered to the negative active material surface. The amount of lithium was calculated so that the potential of the negative active material is lowered to about 0.7V relative to Li/Li+.

An electrode assembly was fashioned by placing a 25 micrometer thick 4 cm by 4 cm porous sheet of polypropylene (e.g, from Ube Industries, Tokyo, Japan or Celgard LLC, Charlotte, N.C., USA) as a separator against the face of the negative electrode bearing the negative active material layer and then placing the face of the positive electrode bearing that positive active material against the separator, so that the separator was sandwiched between the positive and negative electrodes.

A lithium-ion secondary electrochemical cell was made by placing the electrode assembly in an aluminum laminate pouch and the pouch filled under vacuum with liquid electrolyte (1 M LiPF₆ in 1:2 EC/DMC) in the usual way to saturate the separator, the positive electrode and the negative electrode with electrolyte.

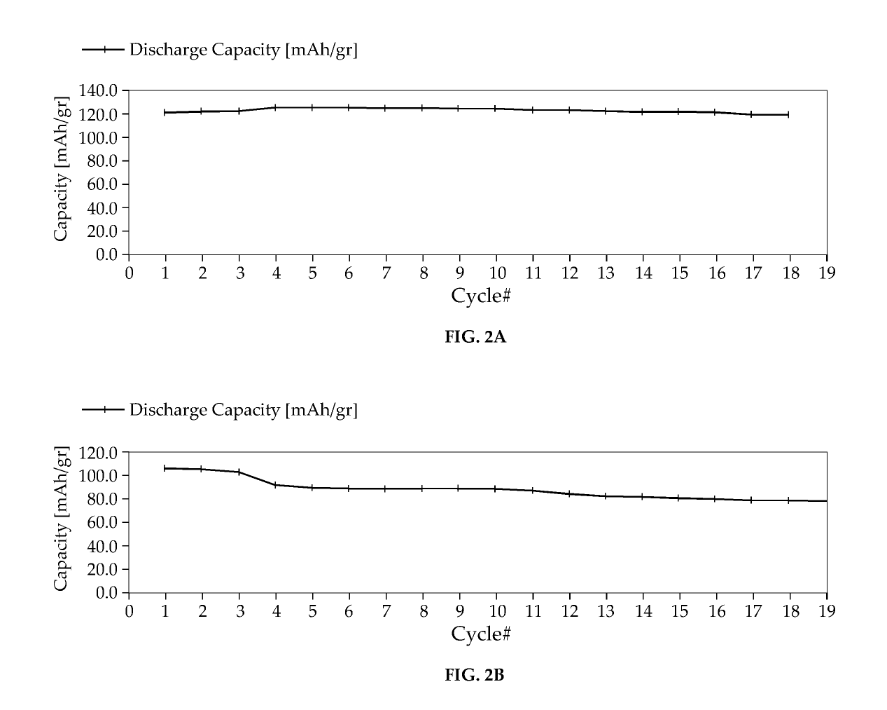

The electrochemical cell was tested in the usual way, including repeated charge/discharge cycles. As seen in FIG. 2A, repeated charge/discharge cycles led to negligible capacity loss when compared to the significant capacity loss of a comparable prior art electrochemical cell (made in the same way, without the lithium metal button applied to the negative active material) as seen in FIG. 2B. The improved performance was attributed to formation of an solution-electrolyte interphase on the surface of the negative active material in accordance with the teachings herein, prior to the formation charge/discharge cycles.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Citation or identification of any balancing in this application shall not be construed as an admission that such balancing is available as prior art to the invention.

Section headings are used herein to ease understanding of the specification and should not be construed as necessarily limiting.

1-25. (canceled)

26. A method of making a lithium-ion secondary electrochemical cell, comprising:
a. providing at least one positive electrode having a height, a breadth and a thickness bearing a lithium-ion containing positive active material on at least one face thereof;
b. providing at least one negative electrode having a height, a breadth and a thickness bearing a lithium-ion intercalating negative active material on at least one face thereof;
c. contacting of lithium metal with said negative active material; and
d. subsequent to c,
placing said positive electrode and said negative electrode, mutually electrically insulated by at least one separator disposed therebetween to constitute an electrode assembly, in a cell-container; and
contacting said negative active material and said lithium metal contacted therewith with an electrolyte during filling of said cell-container with said electrolyte
thereby allowing oxidation of said lithium metal yielding lithium ions, at least some of which are intercalated in said negative active material,
wherein an amount of said lithium metal is less than the amount of lithium intercalating sites of said negative active material.

27. The method of claim 26, wherein said lithium metal constitutes a component including not less than 95% lithium metal by weight.

28. The method of claim 26, wherein said lithium metal constitutes a component having a form selected from the group consisting of threads, wires, ribbons, strips, filaments, chips, particles, powders, buttons and knobs.

29. The method of claim 26, wherein said amount of said lithium metal is not more than 50% of the amount of lithium intercalating sites of said negative active material.

30. The method of claim 26, wherein said amount of said lithium metal is at least 1% of the amount of lithium intercalating sites of said negative active material.

31. The method of claim 26, wherein said amount of said lithium metal is between 20% and 30% of the amount of lithium intercalating sites of said negative active material.

32. The method of claim 26, wherein said amount of said lithium metal is such that said oxidation of said lithium metal to said lithium ions lowers the potential of said negative active material to a predetermined potential.

33. The method of claim 32, wherein said potential to which the potential of said negative active material is lowered is sufficient to lead to reduction of at least one selected component of said electrolyte.

34. The method of claim 33, wherein at least some products of said reduction of at least one component of said electrolyte are deposited on a surface of said negative active material to form at least a portion of a negative electrode SEI.

35. The method of claim 33 wherein said potential to which the potential of said negative active material is lowered is within 200 mV of the potential sufficient to lead to said reduction of said selected component of said electrolyte.

36. The method of claim 33, wherein said selected component of said electrolyte is selected from the group consisting of:
1,3-propane sultone and wherein said potential is not more than 2.1 V relative to Li/Li+;
ethylene sulfite and/or propylene sulfite and wherein said predetermined potential is not more than 2.0 V relative to Li/Li+;
LiBOB and wherein said predetermined potential is not more than 1.7 V relative to Li/Li+;
vinylene carbonate and wherein said predetermined potential is not more than 1.4 V relative to Li/Li+; and
ethylene carbonate and wherein said predetermined potential is not more than 1.3 V relative to Li/Li+.

37. The method of claim 26, said positive active material having an oxidation potential of at least 4.2 V vs. Li/Li+.

38. A lithium-ion secondary electrochemical cell, comprising:
a. an electrode assembly including:
i. at least one positive electrode having a height, a breadth and a thickness bearing a lithium-ion containing positive active material on at least one face thereof;
ii. at least one negative electrode having a height, a breadth and a thickness bearing a lithium-ion intercalating negative active material on at least one face thereof facing said positive electrode; and
iii. a separator disposed between said positive electrode and said negative electrode and electrically insulating said positive electrode from said negative electrode; and
b. an electrolyte contacting said positive electrode, said negative electrode and said separator
wherein a negative electrode SEI on said negative active material includes products of reduction of said electrolyte and is substantially devoid of products formed by reactions at said positive electrode.

39. The electrochemical cell of claim 38, wherein said negative electrode SEI comprises products from reduction of at least one member of the group consisting of 1,3-propane sultone, ethylene sulfite, propylene sulfite, LiBOB, vinylene carbonate and ethylene carbonate.

40. The electrochemical cell of claim 38, said positive active material having an oxidation potential of at least 4.2 V vs. Li/Li+.
